(19) United States
(12) Patent Application Publication
(10) Pub. No.: US 2024/0381004 A1
(43) Pub. Date: Nov. 14, 2024

(54) PHOTOELECTRIC CONVERSION APPARATUS AND PHOTOELECTRIC CONVERSION SYSTEM

(71) Applicant: CANON KABUSHIKI KAISHA, Tokyo (JP)

(72) Inventor: SATORU MIKAJIRI, Gunma (JP)

(21) Appl. No.: 18/656,467

(22) Filed: May 6, 2024

(30) Foreign Application Priority Data
May 12, 2023 (JP) 2023-079585

(51) Int. Cl. H04N 25/78; H04N 25/76; H04N 25/773

(52) U.S. Cl. CPC H04N 25/78; H04N 25/773; H04N 25/7795

(57) ABSTRACT

An apparatus includes a light detector including a photon detection element, a counter configured to count an output of the light detector, a generator configured to reset the counter and generate a flag signal in accordance with a count value of the counter reaching a predetermined value, and a readout circuit configured to process the flag signal. The readout circuit detects occurrence of an event based on a time interval of the flag signal.

### BACKGROUND

### Technical Field

The aspect of the embodiments relates to a photoelectric conversion apparatus and a photoelectric conversion system.

### Description of the Related Art

Japanese Patent Laid-Open No. 2020-123847 discloses a photoelectric conversion apparatus that includes avalanche photodiodes arrayed in a matrix. The avalanche photodiode uses an avalanche multiplication phenomenon caused by a strong electric field induced in the p-n junction portion of a semiconductor to multiply signal charges excited by photons several times to several million times.

Japanese Patent Laid-Open No. 2020-096347 discloses an asynchronous solid-state image capturing apparatus that operates in accordance with detection of occurrence of an event such as a change of the light amount. The solid-state image capturing apparatus disclosed in Japanese Patent Laid-Open No. 2020-096347 includes a detection pixel that detects occurrence of an event, and a counting pixel that counts the number of photons having entered the avalanche photodiode when the event occurs.

In a photoelectric conversion apparatus that includes a pixel including a photon detection element such as an avalanche photodiode, while it is demanded to improve the function of the pixel, there is a dilemma that pursuing the improvement leads to an increase in pixel size.

### SUMMARY

An apparatus comprising: a light detector including a photon detection element; a counter configured to count an output of the light detector; a generator configured to reset the counter and generate a flag signal in accordance with a count value of the counter reaching a predetermined value; and a readout circuit configured to process the flag signal, wherein the readout circuit detects occurrence of an event based on a time interval of the flag signal.

Further features of the disclosure will become apparent from the following description of exemplary embodiments with reference to the attached drawings.

### BRIEF DESCRIPTION OF THE DRAWINGS

FIG. 1 is a block diagram showing the first arrangement example of a photoelectric conversion apparatus according to the first embodiment;

FIG. 2 is a block diagram showing the second arrangement example of the photoelectric conversion apparatus according to the first embodiment;

FIG. 3 is a view showing an example of the arrangement of a pixel:

FIG. 4 is a perspective view showing an example of the arrangement of the photoelectric conversion apparatus according to the first embodiment;

FIGS. 5A to 5C are views for explaining a basic operation of a photoelectric conversion unit in the photoelectric conversion apparatus according to the first embodiment;

FIG. 6 is a view showing a specific arrangement example of the pixel in the photoelectric conversion apparatus according to the first embodiment;

FIG. 7 is a timing chart exemplarily showing the driving method of the pixel in the photoelectric conversion apparatus according to the first embodiment;

FIG. 8 is a view showing a more specific arrangement example of a counter and a flag signal generation circuit of the pixel in the photoelectric conversion apparatus according to the first embodiment;

FIG. 9 is a view exemplarily showing the driving method of a pixel in a photoelectric conversion apparatus according to the second embodiment;

FIG. 10 is a view exemplarily showing the driving method of a pixel in a photoelectric conversion apparatus according to the third embodiment;

FIG. 11 is a view showing a specific arrangement example of a pixel in a photoelectric conversion apparatus according to the fourth embodiment;

FIGS. 12A to 12C are views showing a specific arrangement example of a counter and a flag signal generation circuit of the pixel in the photoelectric conversion apparatus according to the fourth embodiment;

FIGS. 13A and 13B are views showing a schematic arrangement of a photoelectric conversion apparatus according to the fifth embodiment;

FIGS. 14A and 14B are views showing a schematic arrangement of a photoelectric conversion apparatus according to the sixth embodiment;

FIG. 15 is a view showing a configuration example of a photoelectric conversion system;

FIGS. 16A and 16B are views showing another configuration example of the photoelectric conversion system; and

FIG. 17 is a view showing still another configuration example of the photoelectric conversion system.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

With reference to FIGS. 1 to 8, a photoelectric conversion apparatus 100 according to the first embodiment of the present disclosure will be described.

FIG. 1 is a block diagram exemplarily showing the schematic arrangement of the photoelectric conversion apparatus 100. As exemplarily shown in FIG. 1, the photoelectric conversion apparatus 100 can include a pixel portion 10, a vertical scanning circuit 40, a readout circuit 50, a horizontal scanning circuit 60, a controller 80, and an output circuit 90. In the following description, the photoelectric conversion apparatus 100 will be exemplarily described as an asynchronous image capturing apparatus that uses a photon detection element such as an avalanche photodiode. However, the photoelectric conversion apparatus 100 may be formed as another apparatus. For example, the photoelectric conversion apparatus 100 can be formed as a distance measuring apparatus (for example, a focus detection apparatus or a distance measuring apparatus using Time Of Flight (TOF)) or a light measuring apparatus (for example, an apparatus that measures the incident light amount).

The pixel portion 10 can include a plurality of pixels 12 arranged in an array so as to form a plurality of rows and a plurality of columns. As will be described later, each pixel 12 can include a light detector which includes a photon detection element such as an avalanche photodiode, and a signal processer which processes a signal output from the light detector. The number of the plurality of pixels 12 forming the pixel portion 10 is not particularly limited. For example, it is possible to form the pixel portion 10 by the plurality of pixels 12 arranged in an array including several thousand rows x several thousand columns, like a general digital camera. Alternatively, the pixel portion 10 may be formed by the plurality of pixels 12 arranged in one row or one column. Alternatively, the pixel portion 10 may be formed by one pixel 12.

In each row of the pixel portion 10 formed as a pixel array, a control line 14 extending in a first direction (a lateral direction in FIG. 1) can be arranged. The control line 14 can be connected to each of at least two pixels 12 arranged in the first direction, and used to control these pixels 12. The first direction in which the control line 14 extends may be understood as a row direction or a horizontal direction. Each control line 14 can include a plurality of signal lines for supplying a plurality of kinds of control signals to the pixel 12.

In each column of the pixel portion 10 formed as the pixel array, a data line 16 extending in a second direction (a longitudinal direction in FIG. 1) intersecting the first direction can be arranged. The data line 16 can be connected to each of at least two pixels 12 arranged in the second direction, and used to read out signals from these pixels 12. The second direction in which the data line 16 extends may be understood as a column direction or a vertical direction. Each data line 16 can include a plurality of signal lines for transferring the respective bits of a multi-bit digital signal output from the pixel 12.

The control line 14 in each row can be connected to the vertical scanning circuit 40. The vertical scanning circuit 40 can receive a control signal output from the controller 80, generate control signals for driving the plurality of pixels 12, and supply the control signals to the pixels 12 via the control lines 14. The vertical scanning circuit 40 can include a logic circuit such as a shift register and/or an address decoder. The vertical scanning circuit 40 can be configured to sequentially select the plurality of pixels 12 in the pixel portion 10 on a row basis, that is, to vertically scan the plurality of pixels 12 in the pixel portion 10. The pixel signal of the pixel 12 in the selected row can be supplied to the readout circuit 50 via the data line 16.

The data line 16 in each column can be connected to the readout circuit 50. The readout circuit 50 may include a plurality of holders (not shown) provided so as to correspond to the respective columns of the pixel portion 10 as the pixel array, and can hold, by the holding holder of the corresponding columns, the pixel signals of the pixels 12 in the plurality of columns output on a row basis from the pixel portion 10 via the data lines 16.

The horizontal scanning circuit 60 can receive a control signal output from the controller 80, generate a control signal for reading out the pixel signal from the holder of each column of the readout circuit 50, and supply the control signal to the readout circuit 50.

The horizontal scanning circuit 60 can include a logic circuit such as a shift register and/or an address decoder. The horizontal scanning circuit 60 can be configured to sequentially select the holders of the plurality of columns of the readout circuit 50, that is, to horizontally scan the holders of the plurality of columns. The pixel signal held by the holder of the selected column can be supplied to the output circuit 90.

The output circuit 90 can include an external interface circuit, and output the pixel signal output from the readout circuit 50 to the outside of the photoelectric conversion apparatus 100. The external interface circuit included in the output circuit 90 is not particularly limited. The external interface circuit can be formed by, for example, a SERializer/DESerializer (SerDes) transmission circuit. The SerDes transmission circuit is, for example, a Low Voltage Differential Signaling (LVDS) circuit or a Scalable Low Voltage Signaling (SLVS) circuit.

The controller 80 can generate control signals for controlling operations of the vertical scanning circuit 40, the readout circuit 50, and the horizontal scanning circuit 60, and timings thereof. At least some of the control signals for controlling operations of the vertical scanning circuit 40, the readout circuit 50, and the horizontal scanning circuit 60 and timings thereof may be supplied from the outside of the photoelectric conversion apparatus 100.

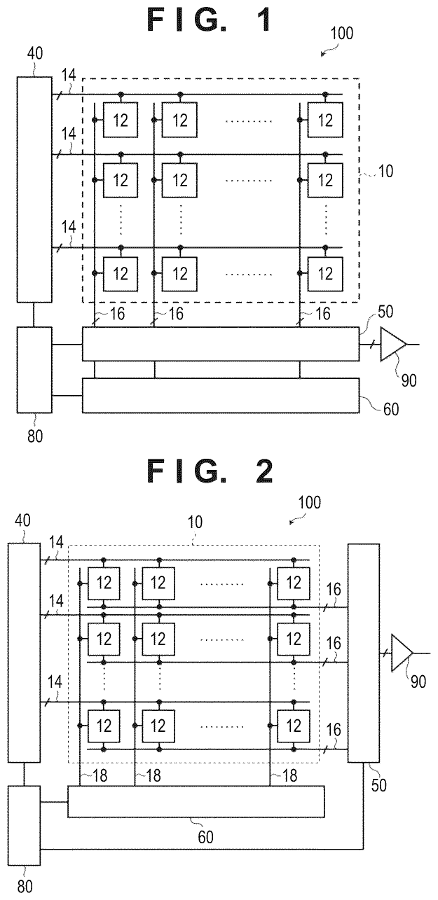

The connection mode of the respective functional blocks of the photoelectric conversion apparatus 100 is not limited to the arrangement example shown in FIG. 1, and may be formed, for example, as exemplarily shown in FIG. 2. In the arrangement example shown in FIG. 2, the data line 16 extending in the first direction is arranged in each row of the pixel portion 10 as the pixel array. The data line 16 can be connected to each of at least two pixels 12 arranged in the first direction, and used to control these pixels 12. In each column of the pixel portion 10 as the pixel array, a control line 18 extending in the second direction is arranged. The control line 18 can be connected to each of at least two pixels 12 arranged in the second direction, and used to read out signals from these pixels 12.

The control lines 18 of the plurality of columns can be connected to the horizontal scanning circuit 60. The horizontal scanning circuit 60 can receive a control signal output from the controller 80, generate a control signal for reading out a pixel signal from the pixel 12, and supply the control signal to the pixel 12 via the control line 18. More specifically, the horizontal scanning circuit 60 can be configured to sequentially select the plurality of pixels 12 in the pixel portion 10 on a column basis, that is, to horizontally scan the plurality of pixels 12 in the pixel portion 10. The pixel signal of the pixel 12 belonging to the selected column can be output to the data line 16.

The data line 16 in each row can be connected to the readout circuit 50. The readout circuit 50 may include a plurality of holders (not shown) provided so as to correspond to the respective rows of the pixel portion 10 as the pixel array, and can hold, by the holders of the corresponding rows, the pixel signals of the pixels 12 in the plurality of rows output on a column basis from the pixel portion 10 via the data lines 16. The readout circuit 50 can receive a control signal output from the controller 80, and sequentially output the pixel signals held by the holders of the respective rows to the output circuit 90. The remaining arrangement in the arrangement example shown in FIG. 2 can be similar to that in the arrangement example shown in FIG. 1.

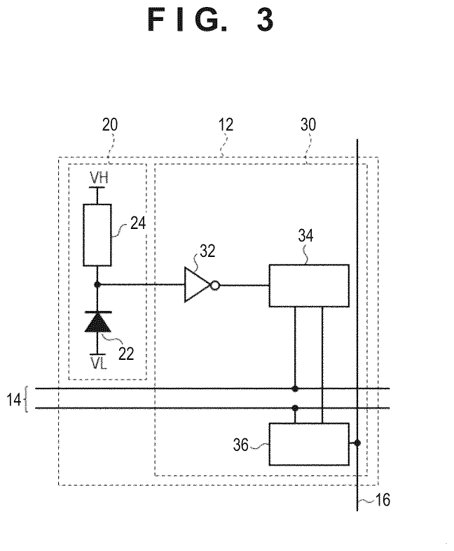

As exemplarily shown in FIG. 3, each pixel 12 can include a light detector 20 and a signal processer 30. The light detector 20 can include, for example, a photon detection element 22 and a quenching element 24. The signal processer 30 can include, for example, a waveform shaper 32, a processing circuit 34, and a pixel output circuit 36.

The photon detection element 22 can be, for example, an avalanche photodiode (to be referred to as an “APD” hereinafter). The anode of the APD forming the photon detection element 22 can be connected to a node to which a voltage VL is supplied. The cathode of the APD forming the photon detection element 22 can be connected to one terminal of the quenching element 24. The connection node connecting the photon detection element 22 and the quenching element 24 can be understood as the output node of the light detector 20. The other terminal of the quenching element 24 can be connected to a node to which a voltage VH higher than the voltage VL is supplied. The voltage VL and the voltage VH can be set so as to apply a sufficient reverse bias voltage for the APD to perform an avalanche multiplication operation. In an example, a negative high voltage is applied as the voltage VL, and a positive voltage at a similar level to a power supply voltage is applied as the voltage VH. For example, the voltage VL is −30 V, and the voltage VH is 1 V.

The photon detection element 22 can be formed by the APD as has been described above. When a sufficient reverse bias voltage for performing an avalanche multiplication operation is supplied to the APD, electric charges generated by incident light to the APD causes avalanche multiplication, and an avalanche multiplication current is generated. The operation mode in a state in which the reverse bias voltage is supplied to the APD includes a Geiger mode and a linear mode. The Geiger mode is an operation mode in which the voltage applied between the anode and the cathode is set to a reverse bias voltage higher than the breakdown voltage of the APD. The linear mode is an operation mode in which the voltage applied between the anode and the cathode is set to a reverse bias voltage about or lower than the breakdown voltage of the APD. The APD operated in the Geiger mode is called a Single Photon Avalanche Diode (SPAD). The APD forming the photon detection element 22 may be operated in the linear mode or the Geiger mode.

The quenching element 24 can have a function of converting a change in avalanche multiplication current generated in the photon detection element 22 into a voltage signal. The quenching element 24 can function as a load circuit (quenching circuit) at the time of signal multiplication by avalanche multiplication, and have a function of suppressing avalanche multiplication by decreasing the voltage applied to the photon detection element 22. The operation of the quenching element 24 for suppressing avalanche multiplication is called a quenching operation. The quenching element 24 can also have a function of returning the voltage supplied to the photon detection element 22 to the voltage VH by flowing a current corresponding to a voltage drop caused by the quenching operation. The operation of the quenching element 24 for returning the voltage supplied to the photon detection element 22 to the voltage VH is called a recharging operation. The quenching element 24 can be formed by a resistor element, a MOS transistor, or the like.

The waveform shaper 32 includes an input node to which an output signal of the light detector 20 is supplied, and an output node. The waveform shaper 32 can have a function of converting an analog signal supplied from the light detector 20 into a pulse signal. As exemplarily shown in FIG. 3, the waveform shaper 32 can be formed by an inverter circuit or the like. The output node of the waveform shaper 32 can be connected to the processing circuit 34.

The processing circuit 34 can include an input node to which an output signal of the waveform shaper 32 is supplied, an input node connected to the control line 14, and an output node. The processing circuit 34 includes a counter to be described later. The counter has a function of counting the pulse superimposed on the signal output from the waveform shaper 32, and holding the count value as a result of counting. The signal supplied from the vertical scanning circuit 40 to the processing circuit 34 via the control line 14 can include a timer clock signal for controlling the pulse count period (exposure period) or the like. The output node of the processing circuit 34 can be connected to the data line 16 via the pixel output circuit 36.

The pixel output circuit 36 can have a function of switching the electric connection state (connection or non-connection) between the processing circuit 34 and the data line 16. The pixel output circuit 36 can switch the connection state between the processing circuit 34 and the data line 16 in accordance with the control signal supplied from the vertical scanning circuit 40 via the control line 14 (in the arrangement example shown in FIG. 2, the control signal supplied from the horizontal scanning circuit 60 via the control line 18). The pixel output circuit 36 can include a buffer circuit for outputting a signal.

The pixel 12 is typically a unit structure that outputs a pixel signal for forming an image. However, if the purpose is to measure the distance by using the Time of Flight (TOF) method or the like, the pixel 12 is not necessarily a unit structure that outputs a pixel signal for forming an image. That is, the pixel 12 can be a unit structure that outputs a signal for measuring the arrival time of light and the light amount.

The signal processer 30 is not necessarily provided for each pixel 12, and one signal processer 30 may be provided for the plurality of pixels 12. In this case, it is possible to sequentially execute signal processing operations of the plurality of pixels 12 by using one signal processer 30.

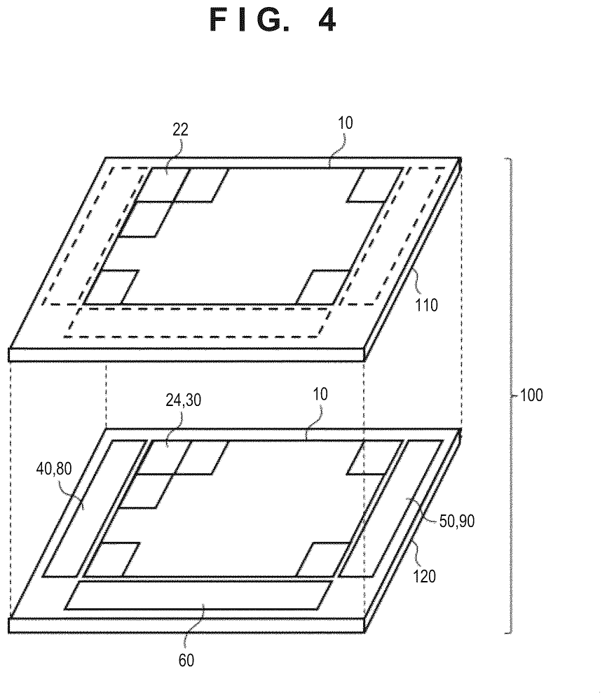

The photoelectric conversion apparatus 100 according to this embodiment may be formed on one substrate, or may be formed as a stacked type photoelectric conversion apparatus formed by stacking a plurality of substrates. In the latter case, for example, as exemplarily shown in FIG. 4, the photoelectric conversion apparatus 100 can be formed as a stacked type photoelectric conversion apparatus in which a sensor substrate 110 and a circuit substrate 120 are stacked and electrically connected. Among the components of the pixel 12, at least the photon detection element 22 can be arranged on the sensor substrate 110. Among the components of the pixel 12, the quenching element 24 and the signal processer 30 can be arranged on the circuit substrate 120. The photon detection element 22 is electrically connected to the quenching element 24 and the signal processer 30 via connection wirings provided for each pixel 12. The vertical scanning circuit 40, the readout circuit 50, the horizontal scanning circuit 60, the controller 80, the output circuit 90, and the like can further be arranged on the circuit substrate 120.

In each pixel 12, the photon detection element 22, the quenching element 24, and the signal processer 30 may be arranged on the sensor substrate 110 and the circuit substrate 120 so as to overlap in a planar view. The vertical scanning circuit 40, the readout circuit 50, the horizontal scanning circuit 60, the controller 80, and the output circuit 90 can be arranged around the pixel portion 10 formed by the plurality of pixels 12. Note that in this specification, “a planar view” refers to viewing from a direction perpendicular to the light incident surface of the sensor substrate 110.

By forming the stacked-type photoelectric conversion apparatus 100, the integration degree of elements can be increased, and the function can be improved. Particularly, by arranging the photon detection element 22 on the substrate different from the substrate of the quenching element 24 and the signal processer 30, it is possible to arrange the photon detection elements 22 at high density without sacrificing the light receiving area of the photon detection elements 22. Thus, the photon detection efficiency can be improved. The number of substrates forming the photoelectric conversion apparatus 100 is not limited two, and three or more substrates may be stacked to form the photoelectric conversion apparatus 100.

In the example shown in FIG. 4, a diced chip is assumed as each of the sensor substrate 110 and the circuit substrate 120, but the sensor substrate 110 and the circuit substrate 120 are not limited to chips. For example, each of the sensor substrate 110 and the circuit substrate 120 may be a wafer. Alternatively, the sensor substrate 110 and the circuit substrate 120 may be stacked as wafers and then diced, or may be formed into chips and then stacked/bonded.

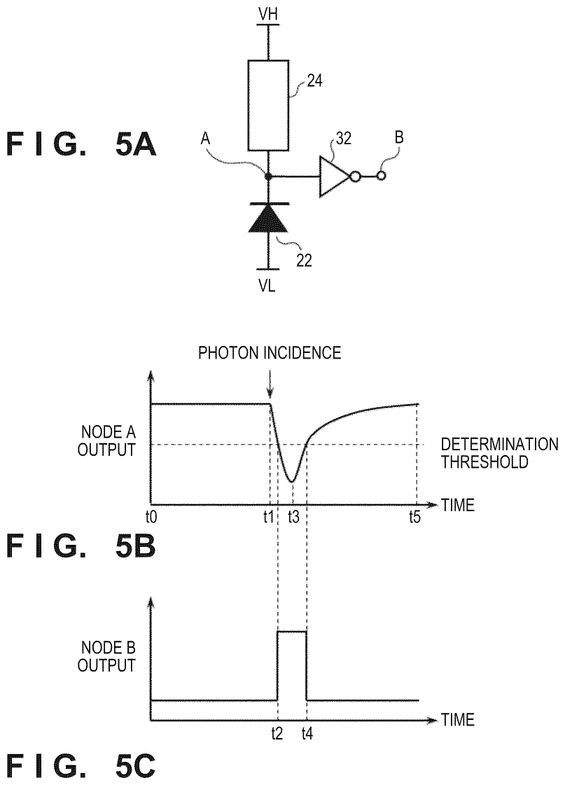

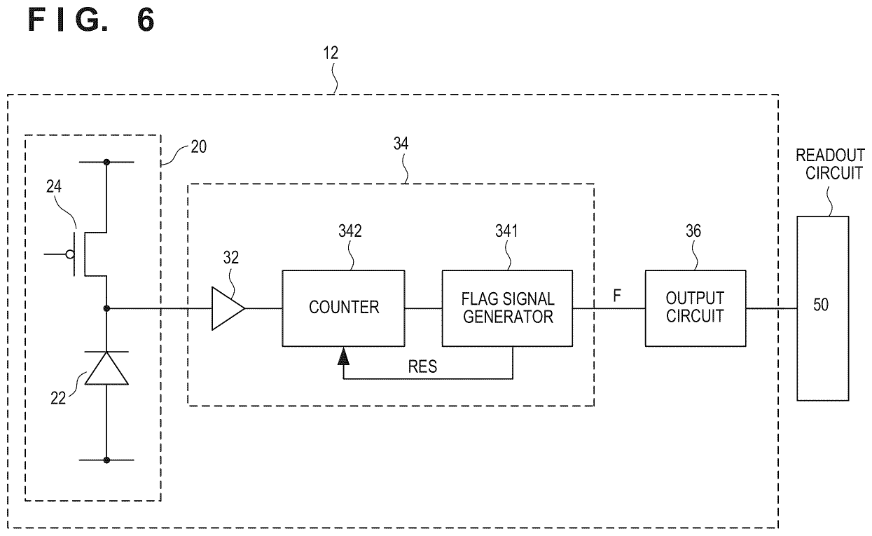

FIGS. 5A to 5C are views for explaining a basic operation of the light detector 20 and the waveform shaper 32. FIG. 5A is a circuit diagram showing the light detector 20 and the waveform shaper 32, FIG. 5B shows the waveform of a signal at the input node (node A) of the waveform shaper 32, and FIG. 5C shows the waveform of a signal at the output node (node B) of the waveform shaper 32. Note that for the sake of descriptive simplicity, a case in which the waveform shaper 32 is formed by an inverter circuit is assumed here.

At time t0, a reverse bias voltage of a potential difference corresponding to (VH−VL) is applied to the photon detection element 22. A sufficient reverse bias voltage for causing avalanche multiplication is applied between the anode and cathode of the APD forming the photon detection element 22. In a state in which no photon enters the photon detection element 22, no carrier for causing avalanche multiplication exits. Accordingly, avalanche multiplication does not occur in the photon detection element 22, so no current flows through the photon detection element 22.

At following time t1, a photon enters the photon detection element 22. When a photon enters the photon detection element 22, an electron-hole pair is generated by photoelectric conversion. These carriers cause avalanche multiplication, and an avalanche multiplication current flows through the photon detection element 22. When the avalanche multiplication current flows through the quenching element 24, the quenching element 24 causes a voltage drop, and the voltage of the node A starts to drop. When the voltage drop amount of the node A increases and the avalanche multiplication stops at time t3, the voltage level of the node A does not drop any more.

When the avalanche multiplication in the photon detection element 22 stops, a current that compensates for the voltage drop flows from the node supplied with the voltage VL to the node A via the photon detection element 22, so that the voltage of the node A gradually increases. Thereafter, the node A is settled to the original voltage level at time t5.

The waveform shaper 32 binarizes the signal input from the node A in accordance with a predetermined determination threshold, and outputs the signal from the node B. More specifically, if the voltage level of the node A is higher than the determination threshold, the waveform shaper 32 outputs a low-level signal from the node B. If the voltage level of the node A is equal to or lower than the determination threshold, the waveform shaper 32 outputs a high-level signal from the node B. For example, assume that the voltage of the node A is equal to or lower than the determination threshold in the period from time t2 to time t4 as shown in FIG. 5B. In this case, as shown in FIG. 5C, the signal level at the node B is low in the period from time t0 to time t2 and the period from time t4 to time t5, and high in the period from time t2 to time t4.

In this manner, the analog signal input from the node A is waveform-shaped into a digital signal by the waveform shaper 32. A pulse signal output from the waveform shaper 32 in accordance with the photon entering the photon detection element 22 can be understood as a photon detection pulse signal.

FIG. 6 is a view for explaining the arrangement of the pixel 12 in more detail. In the description of FIG. 6, the description of the portion that overlaps FIG. 3 or FIGS. 5A to 5C will be omitted or simplified. In this embodiment, the processing circuit 34 includes a counter 342 and a flag signal generator 341. The processing circuit 34 may include the waveform shaper 32. The counter 342 can count the output of the photon detection element 22, more specifically, the pulse based on the photon having entered the photon detection element 22, and hold the count value as the count result. In order to hold the count value, the counter 342 can include a multibit memory capable of holding a multibit digital signal, for example, a plurality of flip flops. The count value held by the counter 342 is output to the flag signal generator 341.

In accordance with the output of the counter 342 reaching a predetermined value (predetermined count value), the flag signal generator 341 can generate a reset signal RES for resetting the counter 342, and generate a flag signal F. The counter 342 is reset by the reset signal RES from the flag signal generator 341. The flag signal generator 341 can be a digital circuit configured to perform arithmetic processing based on the count value as a digital signal. The readout circuit 50 can be configured to read out, via the pixel output circuit 36, the generated flag signal F from the flag signal generator 341.

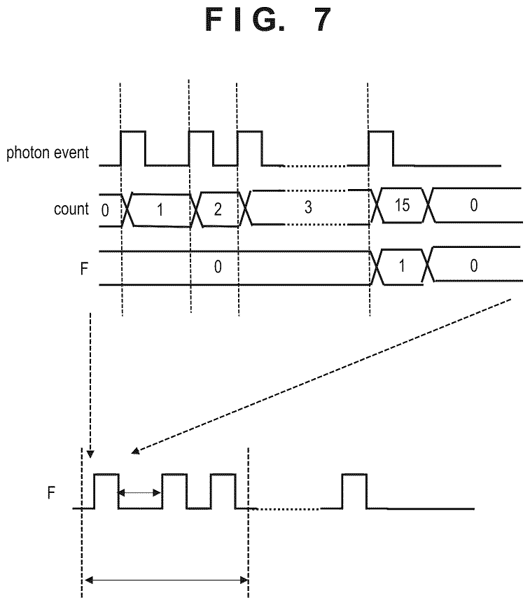

FIG. 7 shows a timing chart of the operation of the pixel 12. As has been described above, the counter 342 counts the pulse based on the photon having entered the photon detection element 22, and counts up in the example shown in FIG. 7. In the example shown in FIG. 7, the number of bits of the counter 342 is four. If the count value of the pulses based on the photons having entered the photon detection element 22 reaches 15 (predetermined value), the count value of the counter 342 is saturated. Here, if the count value of the counter 342 reaches 15 (predetermined value), the flag signal generator 341 generates (activates) the flag signal F as shown in FIG. 7. In addition, if the count value of the counter 342 reaches 15 (predetermined value), the flag signal generator 341 generates the reset signal RES for resetting the counter 342. The counter 342 is reset by the reset signal RES, and the count value is returned to 0.

In a general counter, if the count value is saturated, the count value is returned to 0 in response to the input of the next pulse. In this case, the count of the next pulse is missed. To avoid this, if the count value of the counter 342 reaches 15 (predetermined value), the flag signal generator 341 generates the reset signal RES for resetting the counter 342.

The readout circuit 50 can receive the flag signal F output from the flag signal generator 341, and detect occurrence of an event based on the flag signal F. If occurrence of an event is detected, this means that the amount of light having entered the photon detection element 22 of the pixel 12 satisfies a predetermined condition. This predetermined condition may be that the difference in count value between two or more pixels 12 exceeds a predetermined threshold, or may be that the change amount of the count value exceeds a predetermined threshold.

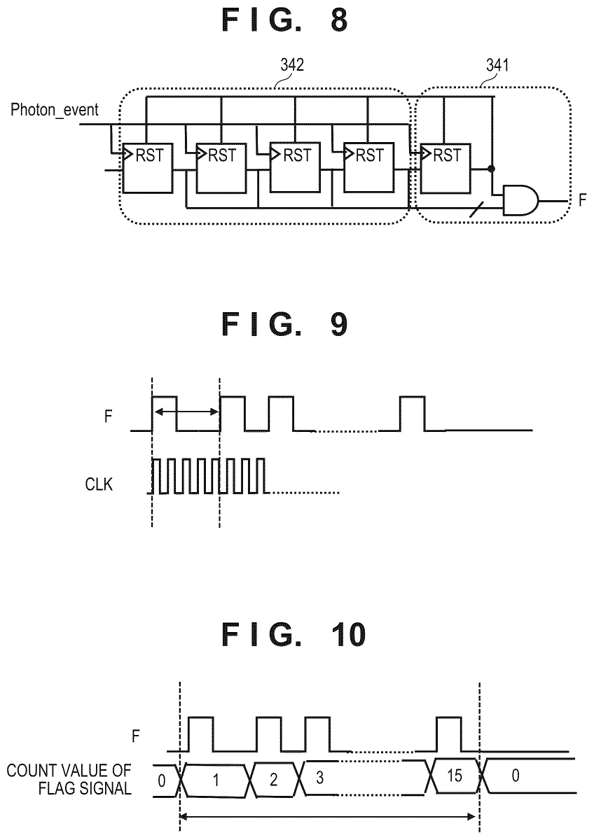

FIG. 8 shows an example of a specific circuit including the counter 342 and the flag signal generator 341. The counter 342 can be formed by, for example, a plurality of flip flops.

The flag signal generator 341 can be formed by, for example, a flip flop and a logic circuit (an AND circuit in the example shown in FIG. 8). If the number of bits of the counter 342 is four, the flag signal generator 341 can include a flip flop arranged so as to be the fifth bit.

The output of the fifth-bit flip flop can be connected to the reset terminals of all the flip flops so that all of the counter 342 and the fifth-bit flip flop are reset in response to transition of the output of the fifth bit to an active level. In the circuit example shown in FIG. 8, the pulse width of the flag signal F is decided by the output delay of the flip flop and the reset delay.

### Second Embodiment

With reference to FIG. 9, a photoelectric conversion apparatus 100 according to the second embodiment of the present disclosure will be described. Note that matters not mentioned as the second embodiment can follow the first embodiment. In the second embodiment, occurrence of an event is detected based on a flag signal F generated in accordance with a count value of pulses based on photons having entered a photon detection element 22.

FIG. 9 exemplarily shows an operation of detecting occurrence of an event by measuring the time interval between the adjacent flag signals F. The pulse of the flag signal F is generated when the count value of a counter 342 reaches a predetermined value. Accordingly, by measuring the pulse interval of the adjacent flag signals F, it is possible to know the interval at which the count value of photons reaches the predetermined value, that is, the number of photons having entered the photon detection element 22. The pulse interval can be measured as, for example, the time from the leading edge of the pulse to the leading edge of the next pulse as exemplarily indicated by an arrow in FIG. 9. Alternatively, the pulse interval can be measured by, for example, using a counter that counts a clock signal CLK whose period is sufficiently shorter than the interval of the pulse signal. Measurement of the pulse interval, that is, detection of occurrence of an event can be performed by, for example, a readout circuit 50. The readout circuit 50 can be configured to detect occurrence of an event, for example, when the pulse interval exceeds a first threshold or when the change amount of the pulse interval exceeds a second threshold.

### Third Embodiment

With reference to FIG. 10, a photoelectric conversion apparatus 100 according to the third embodiment of the present invention will be described. Note that matters not mentioned as the third embodiment can follow the first embodiment. In the third embodiment, occurrence of an event is detected based on the count value (the number of times of occurrence) of a flag signal F generated in accordance with a count value of pulses based on photons having entered a photon detection element 22.

FIG. 10 exemplarily shows an operation of detecting occurrence of an event based on the count value of pulses of the flag signal F in a predetermined period. The pulse of the flag signal F is generated when the count value of a counter 342 reaches a predetermined value. Accordingly, by counting the number (number of times of occurrence) of pulses of the flag signal F, it is possible to know the number of photons having entered the photon detection element 22. Counting the pulse of the flag signal F is equivalent to counting the number of times the fifth bit becomes active for the 4-bit counter 342. A readout circuit 50 includes a counter (second counter) that counts the flag signal F, and can be configured to detect occurrence of an event when the count value by the counter (second counter) exceeds a third threshold or when the change amount of the count value exceeds a fourth threshold.

### Fourth Embodiment

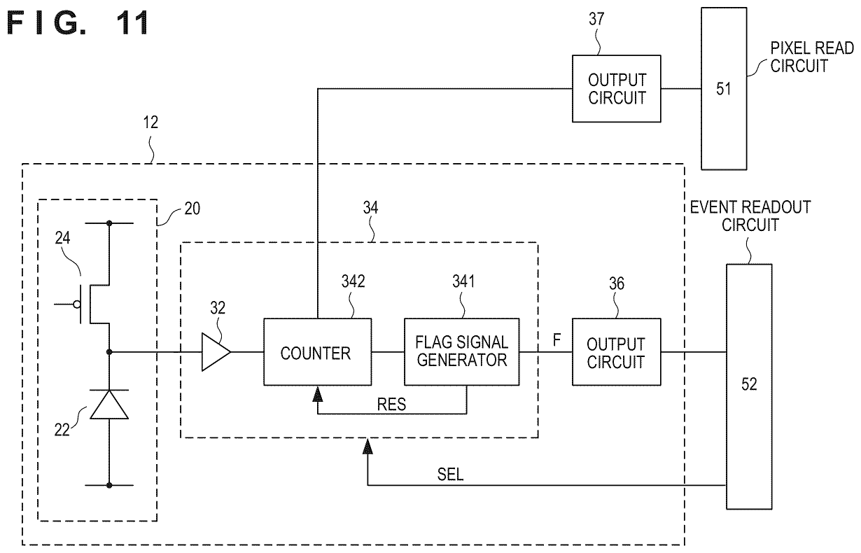

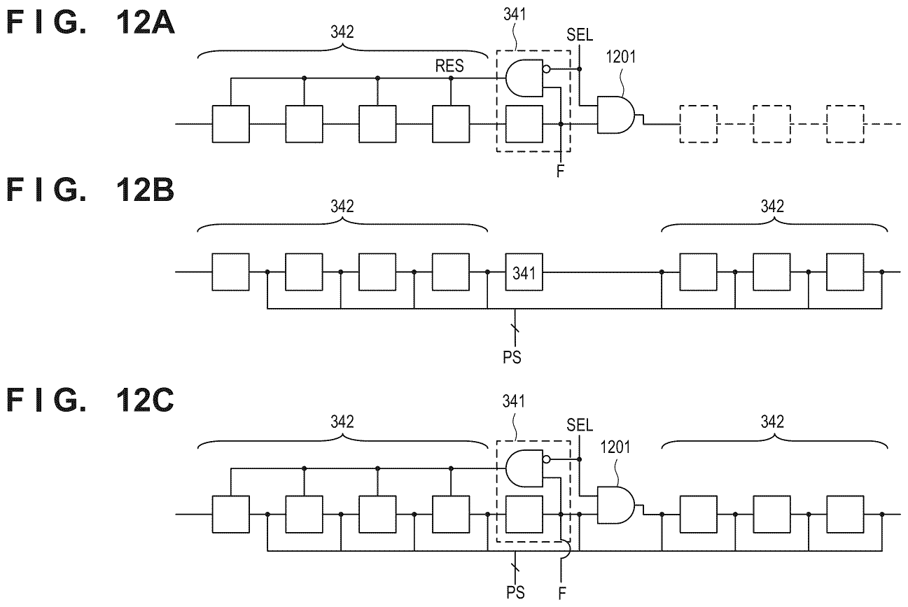

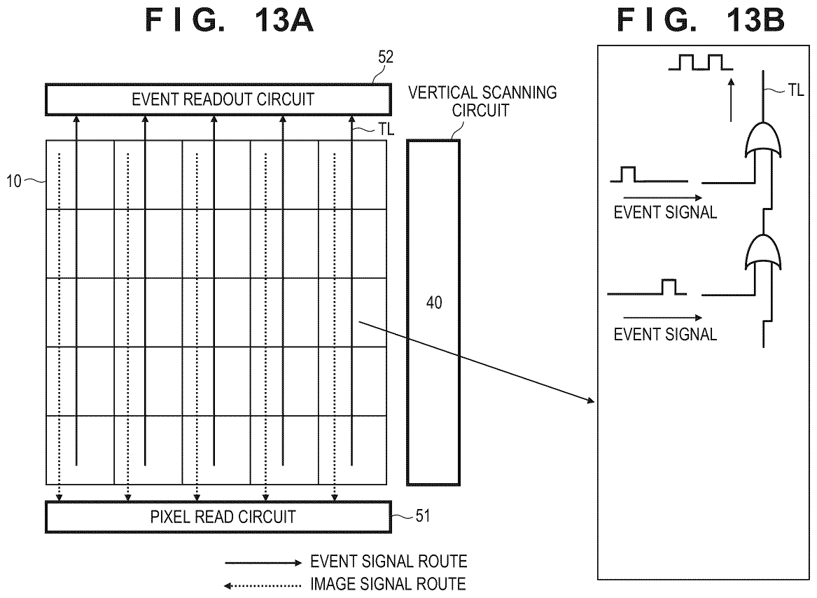

With reference to FIGS. 11 and 12A to 12C, a photoelectric conversion apparatus 100 according to the fourth embodiment of the present disclosure will be described. Note that matters not mentioned as the fourth embodiment can follow the first embodiment. In the fourth embodiment, a readout circuit 50 not only detects occurrence of an event but also reads out a pixel signal.

FIG. 11 exemplarily shows the arrangement of a pixel 12 and the arrangement of the readout circuit 50. A processing circuit 34 of the pixel 12 includes a counter 342 and a flag signal generator 341, as in the first embodiment. The readout circuit 50 includes a pixel readout circuit 51 and an event readout circuit 52. The counter 342 can count the output of a photon detection element 22, more specifically, the pulse based on the photon having entered the photon detection element 22, and hold the count value as the count result. The count value held by the counter 342 is output to the flag signal generator 341. In accordance with the output of the counter 342 reaching a predetermined value (predetermined count value), the flag signal generator 341 can generate a reset signal RES for resetting the counter 342, and generate a flag signal F. The counter 342 is reset by the reset signal RES from the flag signal generator 341. The flag signal generator 341 can be a digital circuit configured to be capable of performing arithmetic processing based on the count value as a digital signal.

The event readout circuit 52 can be configured to read out, via a pixel output circuit 36, the generated flag signal F from the flag signal generator 341. Further, the event readout circuit 52 can be configured to detect occurrence of an event based on the flag signal F, and in accordance with detection of occurrence of the event, output a SEL signal for switching the operation of the counter 342 to the processing circuit 34. If the SEL signal is received, the processing circuit 34 can transition from the first mode for monitoring occurrence of an event to the second mode for generating a pixel signal. In the second mode, the count value by the counter 342 in a predetermined period (one frame) is output to the pixel readout circuit 51 via a pixel output circuit 37.

With reference to FIGS. 12A to 12C, the arrangement of the counter 342 and the flag signal generator 341 having the first mode and the second mode will be described. FIG. 12A schematically shows the arrangement of the counter 342 and the flag signal generator 341 in the first mode for monitoring occurrence of an event. In the first mode for monitoring occurrence of an event, when the counter 342 is formed by a 4-bit counter as in FIG. 8, the flag signal F is generated by a subsequent flip flop circuit. At this time, flip flops (indicated by dotted lines) forming the upper three bits are inactivated.

FIG. 12B schematically shows the arrangement of the counter 342 and the flag signal generator 341 after detection of occurrence of an event and transition from the first mode to the second mode. In the second mode, the upper three bits inactivated in the first mode are activated. Accordingly, the 8-bit counter is formed by including the 1-bit flip flop circuit used to generate an event flag signal.

FIG. 12C schematically shows the arrangement of the counter 342 and the flag signal generator 341 having the first mode and the second mode. In the first mode, the event readout circuit 52 drives the control signal SEL to logic 0. In the second mode, the event readout circuit 52 drives the control signal SEL to logic 1. The control signal SEL is supplied to a switching circuit 1201. If SEL=0 (first mode), the upper three bits are inactivated. If SEL=1 (second mode), the upper three bits are activated.

That is, in the first mode for monitoring occurrence of an event, the flag signal generator 341 generates the flag signal F and resets the counter 342 in accordance with the count value by the counter 342 reaching the predetermined value. In the second mode for generating the pixel signal, the flag signal generator 341 does not reset the counter 342 even if the count value by the counter 342 reaches the predetermined value. The flag signal generator 341 transitions from the first mode to the second mode in accordance with detection of occurrence of an event by the readout circuit 50. In the first mode, the counter 342 operates as a counter of the first number of bits. In the second mode, the counter 342 operates as a counter of the second number of bits which is larger than the first number of bits.

### Fifth Embodiment

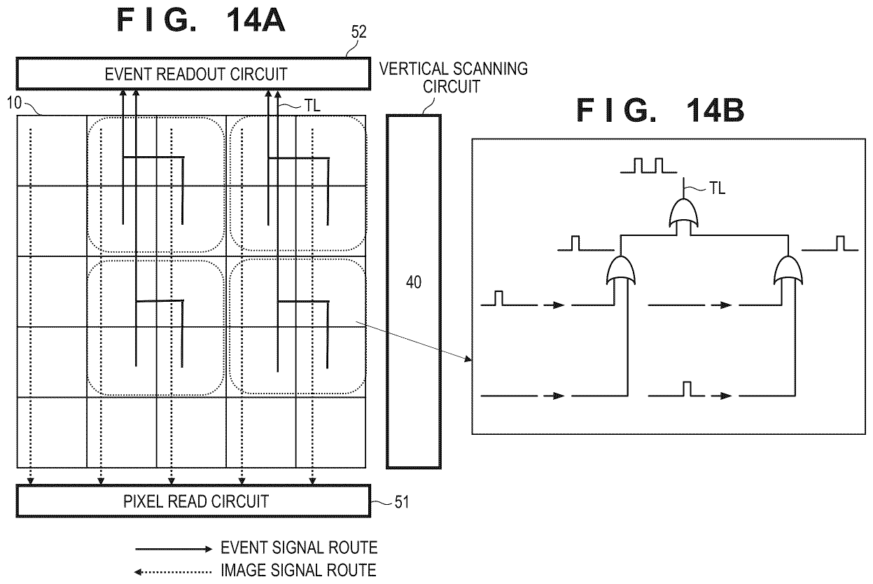

With reference to FIGS. 13A and 13B, a photoelectric conversion apparatus 100 according to the fifth embodiment of the present disclosure will be described. Note that matters not mentioned as the fifth embodiment can follow the first embodiment and the fourth embodiment. As exemplarily shown in FIG. 13A, the photoelectric conversion apparatus 100 can include a pixel portion 10, a vertical scanning circuit 40, a pixel readout circuit 51, and an event readout circuit 52.

The pixel readout circuit 51 can read out a pixel signal from each pixel 12 in the pixel portion 10. The event readout circuit 52 can be configured to read out flag signals from a plurality of pixels 12 in the pixel portion 10. Here, the plurality of pixels 12 in the pixel portion 10 can be divided into a plurality of groups, and each group can be provided with a signal line TL used to transfer a signal corresponding to the outputs of respective flag signal generators 341 of at least two pixels 12 forming the group.

FIG. 13B shows an example in which each group is formed by the pixels 12 in one column.

More specifically, a signal obtained by combining the outputs of the respective flag signal generators 341 of at least two pixels 12 forming the column as the group is read out by the event readout circuit 52 via the signal line TL. According to such the arrangement, no assistance by the vertical scanning circuit 40 is required to read out the flag signal. Further, according to such the arrangement, the arrangement required to read out the flag signal is simplified, so that the entire circuit scale can be decreased. In the example shown in FIGS. 13A and 13B, each group is formed by the pixels 12 in one column, but each group may be formed by, for example, the pixels 12 in one row.

### Sixth Embodiment

With reference to FIGS. 14A and 14B, a photoelectric conversion apparatus 100 according to the sixth embodiment of the present disclosure will be described. Note that matters not mentioned as the sixth embodiment can follow the first embodiment and the fourth embodiment. As exemplarily shown in FIG. 14A, the photoelectric conversion apparatus 100 can include a pixel portion 10, a vertical scanning circuit 40, a pixel readout circuit 51, and an event readout circuit 52.

The pixel readout circuit 51 can read out a pixel signal from each pixel 12 in the pixel portion 10. The event readout circuit 52 can be configured to read out flag signals from a plurality of pixels 12 in the pixel portion 10. Here, the plurality of pixels 12 in the pixel portion 10 can be divided into a plurality of groups, and each group can be provided with a signal line TL used to transfer a signal corresponding to the outputs of respective flag signal generators 341 of at least two pixels 12 forming the group.

FIG. 14B shows an example in which each group is formed by 2×2 pixels 12. In other words, FIG. 14B shows an example in which each group is formed by a two-dimensional region formed by the pixels arranged in at least two rows and at least two columns different from each other.

More specifically, a signal obtained by combining the outputs of the respective flag signal generators 341 of at least four pixels 12 forming the two-dimensional region as the group is read out by the event readout circuit 52 via the signal line TL. According to such the arrangement, no assistance by the vertical scanning circuit 40 is required to read out the flag signal. Further, according to such the arrangement, the arrangement required to read out the flag signal is simplified, so that the entire circuit scale can be decreased.

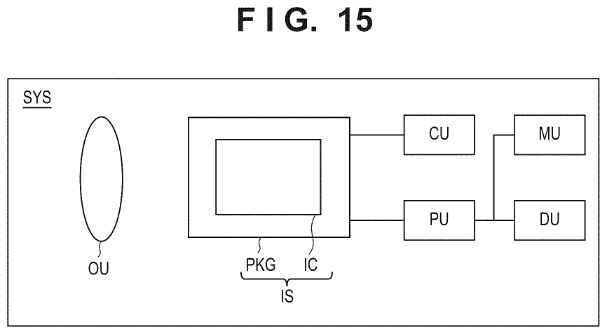

A photoelectric conversion system incorporating the photoelectric conversion apparatus exemplarily described in each embodiment described above will exemplarily be described below. FIG. 15 shows an example of the photoelectric conversion system. The photoelectric conversion apparatus described in each embodiment described above is applicable to various photoelectric conversion systems. Examples of the applicable photoelectric conversion systems are a digital still camera, a digital camcorder, a monitoring camera, a copying machine, a facsimile apparatus, a mobile phone, an in-vehicle camera, and an observation satellite. A camera module including an image capturing apparatus and an optical system such as a lens is also included in the photoelectric conversion systems.

The photoelectric conversion system is formed as, for example, an image capturing system SYS. The image capturing system SYS is a camera or an information terminal having an imaging function. An image capturing apparatus IS can further include a package PKG accommodating the photoelectric conversion apparatus 100 formed as an image capturing device IC. The package PKG can include a base on which the image capturing device IC is fixed, a cover facing the image capturing device IC, and a connection member for connecting a terminal of the base and a terminal of the image capturing device IC. The image capturing apparatus IS can arrange and mount the plurality of image capturing devices IC on the common package PKG. The image capturing apparatus IS can also stack and mount the image capturing device IC and another semiconductor device IC on the common package PKG.

The image capturing system SYS can include an optical system OU that forms an image on the image capturing apparatus IS. The image capturing system SYS can include at least one of a control apparatus CU that controls the image capturing apparatus IS, a processing apparatus PU that processes a signal obtained from the image capturing apparatus IS, and a display apparatus DU that displays an image obtained from the image capturing apparatus IS. Furthermore, the image capturing system SYS may include a storage apparatus MU that stores the image obtained from the image capturing apparatus IS.

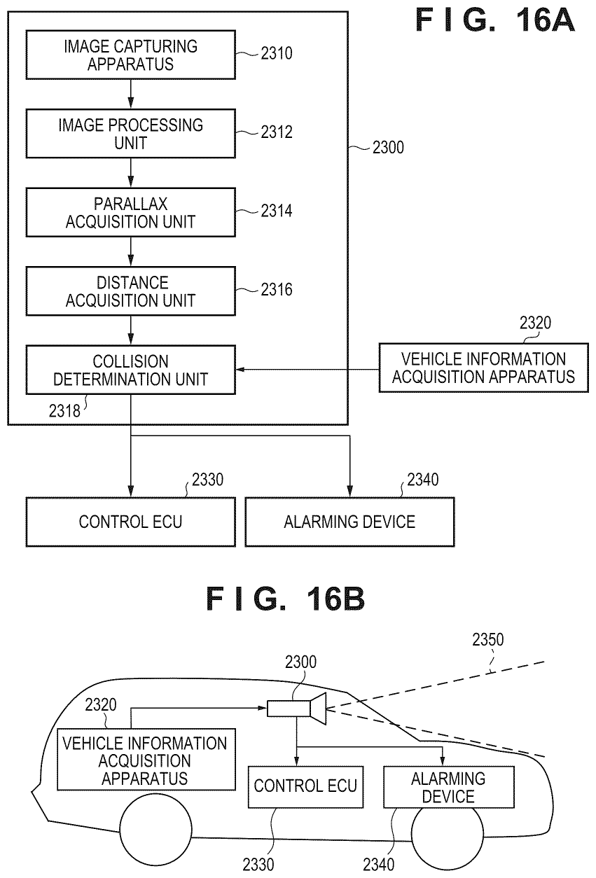

FIG. 16A exemplifies the configuration of a photoelectric conversion system applied to an in-vehicle camera. A photoelectric conversion system 2300 can include the photoelectric conversion apparatus 100 formed as an image capturing apparatus 2310. The photoelectric conversion system 2300 includes an image processor 2312 that performs image processing for a plurality of image data acquired by the image capturing apparatus 2310, and a parallax acquisition unit 2314 that calculates a parallax (the phase difference between parallax images) from the plurality of image data acquired by the photoelectric conversion system 2300. The photoelectric conversion system 2300 also includes a distance acquisition unit 2316 that calculates the distance up to a target object based on the calculated parallax, and a collision determination unit 2318 that determines, based on the calculated distance, whether there is collision possibility. Here, the parallax acquisition unit 2314 and the distance acquisition unit 2316 are examples of a distance information acquisition unit that acquires distance information up to a target object. That is, the distance information is information concerning a parallax, a defocus amount, a distance up to a target object, and the like.

The collision determination unit 2318 may determine collision possibility using one of the pieces of distance information. The distance information acquisition unit may be implemented by exclusively designed hardware, or may be implemented by a software module. The distance information acquisition unit may be implemented by a Field Programmable Gate Array (FPGA) or Application Specific Integrated Circuit (ASIC), or may be implemented by a combination of these.

The photoelectric conversion system 2300 is connected to a vehicle information acquisition apparatus 2320, and can acquire vehicle information such as a vehicle speed, a yaw rate, and a steering angle. The photoelectric conversion system 2300 is also connected to a control ECU 2330 that is a control unit configured to output a control signal for generating a braking force to the vehicle based on the determination result of the collision determination unit 2318. Furthermore, the photoelectric conversion system 2300 is connected to an alarm device 2340 that generates an alarm to the driver based on the determination result of the collision determination unit 2318. For example, if collision possibility is high as the determination result of the collision determination unit 2318, the control ECU 2330 performs vehicle control of braking, releasing the accelerator pedal, or suppressing the engine output, thereby avoiding collision and reducing damage. The alarm device 2340 sounds an alarm, displays alarm information on the screen of a car navigation system or the like, or applies a vibration to the seat belt or a steering wheel, thereby making an alarm to the user. In this embodiment, the periphery of the vehicle, for example, the front or rear side is captured by the photoelectric conversion system 2300.

FIG. 16B shows the photoelectric conversion system configured to capture the front side (image capturing range 2350) of the vehicle. The vehicle information acquisition apparatus 2320 sends an instruction to the photoelectric conversion system 2300 or the image capturing apparatus 2310. With this configuration, it is possible to further improve the accuracy of distance measurement.

An example in which control is executed so as not to collide with another vehicle has been explained above. The system can also be applied to control of performing automated driving following another vehicle or control of performing automated driving without deviating from a lane. Furthermore, the photoelectric conversion system can be applied not only to a vehicle such as an automobile but also to, for example, a moving body (moving apparatus) such as a ship, an airplane, or an industrial robot. In addition, the photoelectric conversion system can be applied not only to a moving body but also to an apparatus that broadly uses object recognition, such as an intelligent transport system (ITS).

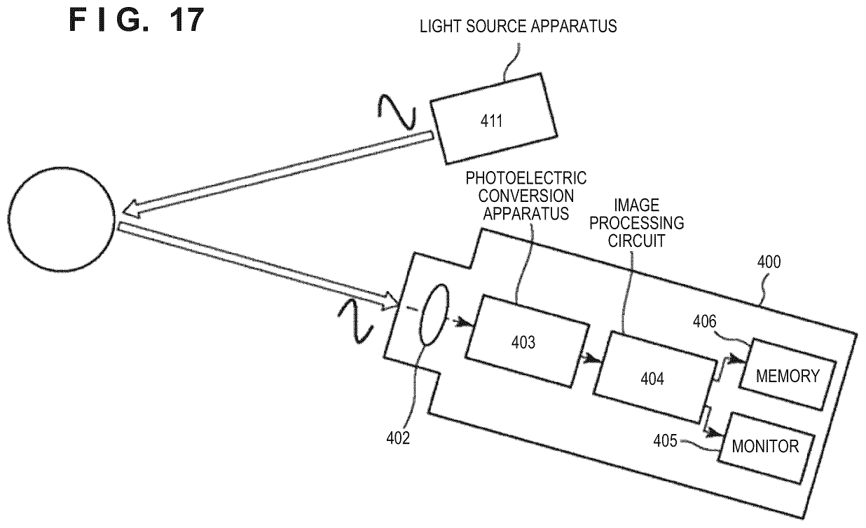

FIG. 17 exemplifies the configuration of a photoelectric conversion system formed as a distance image sensor. A distance image sensor 400 includes an optical system 402, a photoelectric conversion apparatus 403, an image processing circuit 404, a monitor 405, and a memory 406. Then, the distance image sensor 400 can receive light (modulated light or pulsed light) projected from a light source apparatus 411 toward an object and reflected by the surface of the object, thereby acquiring a distance image corresponding to the distance up to the object.

The optical system 407 is formed by including one or a plurality of lenses, and guides image light (incident light) from the object to the photoelectric conversion apparatus 408 and forms an image on the light-receiving surface (sensor portion) of the photoelectric conversion apparatus 408. As the photoelectric conversion apparatus 408, the photoelectric conversion apparatus of each of the above-described embodiments is applied, and a distance signal indicating a distance obtained from a light reception signal output from the photoelectric conversion apparatus 408 is supplied to the image processing circuit 404.

The image processing circuit 404 performs image processing of creating a distance image based on the distance signal supplied from the photoelectric conversion apparatus 408. Then, the distance image (image data) obtained by the image processing is supplied to and displayed on the monitor 405, and supplied to and stored (recorded) in the memory 406. The distance image sensor 400 having such arrangement can acquire, for example, more correct distance image along with improvement in characteristic of pixels by applying the above-described photoelectric conversion apparatus.

The present invention is not limited to the above embodiments and various changes and modifications can be made within the spirit and scope of the present invention. Therefore, to apprise the public of the scope of the present invention, the following claims are made.

According to the present invention, a technique advantageous in improving the function of a pixel and decreasing the pixel size is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-079585, filed May 12, 2023, which is hereby incorporated by reference herein in its entirety.

What is claimed is:

1. An apparatus comprising:
a light detector including a photon detection element;
a counter configured to count an output of the light detector;
a generator configured to reset the counter and generate a flag signal in accordance with a count value of the counter reaching a predetermined value; and
a readout circuit configured to process the flag signal,
wherein the readout circuit detects occurrence of an event based on a time interval of the flag signal.

2. The apparatus according to claim 1, wherein the readout circuit detects occurrence of an event in accordance with the number of times of occurrence of the flag signal in a predetermined period.

3. The apparatus according to claim 1, wherein
in a first mode for monitoring occurrence of an event, the generator resets the counter and generate the flag signal in accordance with the count value by the counter reaching the predetermined value, and in a second mode for generating a pixel signal, the generator does not reset the counter even if the count value by the counter reaches the predetermined value, and
the generator transitions from the first mode to the second mode in accordance with detection of occurrence of an even by the readout circuit.

4. The apparatus according to claim 3, wherein
in the first mode, the counter operates as a counter of a first number of bits, and in the second mode, the counter operates as a counter of a second number of bits larger than the first number of bits.

5. The apparatus according to claim 1, further comprising a plurality of pixels, and each pixel includes the counter and the generator.

6. The apparatus according to claim 5, wherein
the plurality of pixels is divided into a plurality of groups, and each group is provided with a signal line configured to transfer a signal corresponding to outputs of the respective generators of at least two pixels forming the group.

7. The apparatus according to claim 6, further comprising a readout circuit configured to read out a signal transferred through the signal line of each of the plurality of groups.

8. The apparatus according to claim 6, wherein each group corresponds to one row.

9. The apparatus according to claim 6, wherein each group corresponds to one column.

10. The apparatus according to claim 6, wherein each group corresponds to a two-dimensional region formed by pixels arranged in at least two rows and at least two columns.

11. The apparatus according to claim 1, wherein the photon detection element is an avalanche photodiode.

12. A system comprising:
the apparatus defined in claim 1; and
a processor configured to process a signal output by the apparatus.

13. The system according to claim 12, wherein the readout circuit in the apparatus detects occurrence of an event in accordance with the number of times of occurrence of the flag signal in a predetermined period.

14. The system according to claim 12, wherein, in the apparatus,
in a first mode for monitoring occurrence of an event, the generator resets the counter and generate the flag signal in accordance with the count value by the counter reaching the predetermined value, and in a second mode for generating a pixel signal, the generator does not reset the counter even if the count value by the counter reaches the predetermined value, and
the generator transitions from the first mode to the second mode in accordance with detection of occurrence of an even by the readout circuit.

15. The system according to claim 14, wherein, in the apparatus,
in the first mode, the counter operates as a counter of a first number of bits, and in the second mode, the counter operates as a counter of a second number of bits larger than the first number of bits.

16. The system according to claim 12, wherein the apparatus further comprises a plurality of pixels, and each pixel includes the counter and the generator.

17. The system according to claim 16, wherein, in the apparatus,
the plurality of pixels is divided into a plurality of groups, and each group is provided with a signal line configured to transfer a signal corresponding to outputs of the respective generators of at least two pixels forming the group.

18. The system according to claim 17, wherein the apparatus further comprises a readout circuit configured to read out a signal transferred through the signal line of each of the plurality of groups.

19. The system according to claim 17, wherein, in the apparatus, each group corresponds to a two-dimensional region formed by pixels arranged in at least two rows and at least two columns.

20. The system according to claim 12, wherein, in the apparatus, the photon detection element is an avalanche photodiode.
